(19) United States
(12) Patent Application Publication
(10) Pub. No.: US 2026/0146137 A1
(43) Pub. Date: May 28, 2026

(54) THERMOPLASTIC VULCANIZATE CONTAINING BIOPOLYPROPYLENE

(71) Applicant: INDUSTRY-ACADEMIC COOPERATION FOUNDATION GYEONGSANG NATIONAL UNIVERSITY, Gyeongsangnam-do (KR)

(72) Inventors: Jeong Seok OH, Gyeongsangnam-do (KR); Tae Woong GONG, Jeollanam-do (KR); Yongwon CHO, Chungcheongbuk-do (KR)

(73) Assignee: INDUSTRY-ACADEMIC COOPERATION FOUNDATION GYEONGSANG NATIONAL UNIVERSITY, Gyeongsangnam-do (KR)

(21) Appl. No.: 18/878,447

(22) PCT Filed: Jul. 25, 2023
(86) PCT No.: PCT/KR2023/010750

§ 371 Date: Nov. 17, 2025

(30) Foreign Application Priority Data
Jul. 25, 2022 (KR) 10-2022-0091878
Jul. 25, 2023 (KR) 10-2023-0096633

(51) Int. Cl. C08J 3/24; C08F 110/06; C08K 3/06; C08K 3/22; C08K 3/24; C08K 3/30; C08L 23/16

(52) U.S. Cl. CPC C08J 3/24; C08F 110/06; C08K 3/06; C08K 3/22; C08K 3/24; C08L 23/16; C08J 2323/16; C08J 2423/12; C08K 2003/2296; C08K 2003/3009

(57) ABSTRACT

The present disclosure relates to a thermoplastic vulcanizate. The present disclosure can improve mechanical properties such as tensile strength, hardness, thermal stability, etc. while preventing various environmental pollutions in advance by increasing biomass content using an ecofriendly material instead of the conventional petroleum-based materials. Therefore, it can be applied to a wide range of fields as a substitute for the conventional thermoplastic vulcanizates.

### TECHNICAL FIELD

The present disclosure relates to a thermoplastic vulcanizate, more particularly, to a bio-based thermoplastic vulcanizate containing bio-polypropylene.

### BACKGROUND ART

Thermoplastic elastomers are highly functional materials that have both the elasticity of rubbers and the thermoplasticity of plastics. They have excellent physical properties such as shock absorption, processability, and lightweightness, and can be recycled easily because they can be processed easily at high temperatures.

The applications of the thermoplastic elastomers are being expanded throughout daily lives, including automobiles, construction, medicine, sports, footwear, etc. Recently, new demands have emerged such as electric vehicle materials, and their applications are endless.

Among the thermoplastic elastomers, thermoplastic vulcanizates are materials having excellent weather resistance, prepared from chemical polymerization of diene-based monomers. They are gaining increasing attention as an alternative to PVC, which has raised environmental concerns.

Currently, due to various environmental regulations and national/corporate policies for the use of ecofriendly materials, the use of biomaterials is being promoted actively. As a part of such efforts, a polyester-based elastomer resin composition using coffee grounds discarded after brewing has been developed. However, there is a problem that physical properties are deteriorated due to coloring. Therefore, there is an urgent need to develop a new material which is ecofriendly and does not have the problem of deterioration of mechanical properties.

### REFERENCES OF RELATED ART

Patent document 1. Korean Patent Publication No. 10-2023-0063910.

### DISCLOSURE

### Technical Problem

The present disclosure is directed to providing an ecofriendly thermoplastic vulcanizate, which has increased biomass content in a composition and maintains physical properties at a level equivalent to or superior to those of the existing petroleum-based thermoplastic vulcanizate while preventing environmental pollution, and a method for preparing the same.

### Technical Solution

The present disclosure provides a bio-based thermoplastic vulcanizate containing:
a matrix resin containing raw rubber and bio-polypropylene; a sulfur cross-linking agent;
a cross-linking accelerator; and a cross-linking activator.

The content of the raw rubber may be 60 to 70 wt %, and the content of the bio-polypropylene may be 30 to 40 wt %, based on to the total weight of the matrix resin.

The raw rubber may be one or more selected from natural rubber, synthetic rubber, and bio-based rubber. The synthetic rubber may be one or more selected from a group consisting of ethylene-propylene-diene monomer (EPDM) rubber, styrene-butadiene rubber (SBR), butadiene rubber (BR), nitrile rubber (acrylonitrile-butadiene rubber, NBR), polychloroprene rubber, ethylene propylene rubber, urethane rubber, acrylic rubber, Hypalon rubber (CSM), fluorine rubber (FKM), perfluorinated rubber (FFKM), fluorosilicone rubber (FVMQ), and silicone rubber (VMQ), and the bio-based rubber may be one or more selected from a group consisting of bio-ethylene-propylene-diene monomer (bio-EPDM) rubber, bio-butadiene rubber (bio-BR), and bio-thermoplastic polyurethane (bio-TPU), most specifically, ethylene-propylene-diene monomer (EPDM) rubber or bio-ethylene-propylene-diene monomer (bio-EPDM) rubber.

The bio-EPDM rubber may have a specific gravity of 0.8 to 0.9 g/mL and a Mooney viscosity of 75 to 85 at 125° C.

The bio-polypropylene may be polypropylene produced from bioethanol.

The bio-polypropylene may satisfy the following physical properties: (1) specific gravity: 0.9 to 1 g/cm³ and (2) melt index: 40 to 50 g/10 min (220° C., 2.16 kg).

The content of the sulfur cross-linking agent may be 0.5 to 1.5 parts by weight based on 100 parts by weight of the raw rubber.

The content of the cross-linking accelerator may be 0.1 to 6 parts by weight based on 100 parts by weight of the raw rubber.

The content of the cross-linking activator may be 1 to 10 parts by weight based on 100 parts by weight of the raw rubber.

The cross-linking accelerator may be any one selected from a group consisting of TMTD (tetramethylthiuram disulfide), MBTS (2,2′-dithiobis(benzothiazole)) and a mixture thereof, and the cross-linking activator may be any one selected from a group consisting of S/A (stearic acid), ZnO (zinc oxide) and a mixture thereof.

### Advantageous Effects

The present disclosure can improve mechanical properties such as tensile strength, hardness, thermal stability, etc. while preventing various environmental pollutions in advance by increasing biomass content using an ecofriendly material instead of the conventional petroleum-based materials. Therefore, it can be applied to a wide range of fields as a substitute for the conventional thermoplastic vulcanizates.

### BRIEF DESCRIPTION OF DRAWINGS

FIG. 1 shows the TGA curves of thermoplastic vulcanizates prepared in Examples 1 and 2, and Comparative Example 1.

FIG. 2 shows the DSC curves of thermoplastic vulcanizates prepared in Examples 1 and 2, and Comparative Example 1.

FIG. 3 shows the tensile strength of thermoplastic vulcanizates prepared in Examples 1 and 2, and Comparative Example 1.

FIG. 4 shows the elongation at break of thermoplastic vulcanizates prepared in Examples 1 and 2, and Comparative Example 1.

FIG. 5 shows the hardness of thermoplastic vulcanizates prepared in Examples 1 and 2, and Comparative Example 1.

FIG. 6 shows the compression set of thermoplastic vulcanizates prepared in Examples 1 and 2, and Comparative Example 1.

### BEST MODE

Hereinafter, various aspects and exemplary embodiments of the present disclosure will be examined in more detail.

The objects, other objects, features and advantages of the present disclosure will be readily understood through the following specific exemplary embodiments in connection with the attached drawings. However, the present disclosure is not limited to the exemplary embodiments described herein and may be embodied in other forms. Rather, the exemplary embodiments introduced herein are provided to ensure that the disclosure is thorough and complete and to sufficiently convey the spirit of the present disclosure to those skilled in the art.

In this specification, it should be understood that terms such as “include”, “have”, etc. are intended to specify the presence of a feature, number, step, operation, component, part, or combination thereof described in the specification, not to exclude in advance the possibility of the presence or addition of one or more other features, numbers, steps, operations, components, parts, or combinations thereof.

Additionally, when it is said that a component is “connected” or “joined” to another component, it should be understood that it may be directly connected or joined to that other component, and there may also be another component therebetween. On the other hand, when it is said that a component is “directly connected” or “directly joined” to another component, it should be understood that there is no another component therebetween.

In this specification, when a range is described for a variable, it will be understood that the variable includes all values within the described range including the endpoint values of the range. For example, a range of “5 to 10” would be understood to include the values 5, 6, 7, 8, 9 and 10, as well as values within any subranges, such as 6 to 10, 7 to 10, 6 to 9, 7 to 9, etc., and also any value between the integers that fall within the stated range, such as 5.5, 6.5, 7.5, 5.5 to 8.5, 6.5 to 9, etc. Also, for example, a range of “10% to 30%” would be understood to include not only the values 10%, 11%, 12%, 13%, . . . , 30%, but also any subranges such as 10% to 15%, 12% to 18%, 20% to 30%, etc., and also any value between reasonable integers within the stated range, such as 10.5%, 15.5%, 25.5%, etc.

Hereinafter, the present disclosure will be described in detail.

In an aspect, the present disclosure relates to a bio-based thermoplastic vulcanizate containing: a matrix resin containing raw rubber and bio-polypropylene; a sulfur cross-linking agent; a cross-linking accelerator; and a cross-linking activator.

The bio-based thermoplastic vulcanizate according to the present disclosure, which necessarily contains bio-polypropylene unlike the conventional thermoplastic vulcanizates containing petroleum-based resin as a main component, is ecofriendly and has comparable or improved physical properties as compared to the conventional thermoplastic vulcanizates.

The content of the raw rubber may be 60 to 70 wt %, and the content of the bio-polypropylene may be 30 to 40 wt % based on to the total weight of the matrix resin. Most specifically, the content of the raw rubber may be 60 wt %, and the content of the bio-polypropylene may be 40 wt % based on to the total weight of the matrix resin. When this range is satisfied, even if all of the petroleum-based polypropylene in the conventional thermoplastic vulcanizate is replaced with bio-polypropylene, the increase in manufacturing cost of the product can be prevented while maintaining physical properties such as tensile strength, elongation, hardness, compression set, etc. at equivalent or higher levels.

The raw rubber may be one or more selected from natural rubber, synthetic rubber, and bio-based rubber.

The natural rubber may be ordinary natural rubber or modified natural rubber. The ordinary natural rubber can be any known natural rubber and is not limited in the place of origin, etc.

The synthetic rubber may be one or more selected from a group consisting of ethylene-propylene-diene monomer (EPDM) rubber, styrene-butadiene rubber (SBR), butadiene rubber (BR), nitrile rubber (acrylonitrile-butadiene rubber, NBR), polychloroprene rubber, ethylene propylene rubber, urethane rubber, acrylic rubber, Hypalon rubber (CSM), fluorine rubber (FKM), perfluorinated rubber (FFKM), fluorosilicone rubber (FVMQ), and silicone rubber (VMQ).

The bio-based rubber refers to rubber derived from ethanol prepared using biological materials such as sugarcane, corn, soybean, etc., and may be, for example, one or more selected from a group consisting of bio-ethylene-propylene-diene monomer (bio-EPDM) rubber, bio-butadiene rubber (bio-BR), and bio-thermoplastic polyurethane (bio-TPU).

Most specifically, the raw rubber may be ethylene-propylene-diene monomer (EPDM) rubber or bio-ethylene-propylene-diene monomer (bio-EPDM) rubber.

The bio-EPDM rubber may have a specific gravity of 0.8 to 0.9 g/mL and a Mooney viscosity of 75 to 85 at 125° C.

In the present disclosure, the Mooney viscosity may be measured using a Mooney viscometer, and may refer to the torque value of a rotating spindle when a specimen to be measured is placed in a die heated to a specific temperature and then rotated.

The bio-EPDM used in the present disclosure may be Keltan ECO 6950C sold by LANXESS. But, various types of bio-EPDM already known may be used without being limited thereto.

The bio-polypropylene is polypropylene synthesized using biomass as a raw material. It is also called bio-based polypropylene, and is the most important material of the present disclosure. It can be obtained by polymerizing ethylene produced from dehydration of bioethanol. The biomass from which the bioethanol can be produced may be one or more biological resource selected from a group consisting of corn, artichoke, sugarcane, sugar beet, etc. For the sugarcane or sugar beet, bioethanol can be obtained by directly extracting sugar and fermenting it into alcohol. And, for the rest, a liquid fuel such as biomethanol, bioethanol, biodiesel, etc. can be obtained by processing the raw material.

The bio-polypropylene is not particularly limited as long as it is obtained by polymerization from bioethanol and contains organically derived carbon (radioactive carbon, C¹⁴). It may be prepared or polymerized directly, or a commercially available one may be used.

Specifically, in the present disclosure, the bio-polypropylene may be one polymerized from bioethanol satisfying the following physical properties: (1) melt index: 40-50 g/10 min, (2) specific gravity: 0.9-1.0 g/mL, (3) heat deflection temperature: 80-100° C., and (4) Vicat softening point: 150-155.

The bio-polypropylene may be Circulenrenew 448T commercially available from Lyondellbasell. But, various types of bio-PP already known can be used without being limited thereto.

When the bio-polypropylene satisfies the above ranges, even if all petroleum-based polypropylene in the conventional thermoplastic vulcanizate is replaced with bio-polypropylene, ecofriendliness can be improved while maintaining mechanical properties such as tensile strength, elongation at break, hardness, etc. at equivalent or higher levels.

The bio-based thermoplastic vulcanizate according to the present disclosure contains the sulfur cross-linking agent. The content of the sulfur cross-linking agent may be 0.5 to 1.5 parts by weight based on 100 parts by weight of the raw rubber. It is preferred that the content of the cross-linking agent is 0.5 to 1.5 parts by weight, in that it provides an appropriate vulcanizing effect and makes the composition less sensitive to heat and more chemically stable.

The sulfur cross-linking agent may be any one selected from a group consisting of powdered sulfur(S), insoluble sulfur(S), precipitated sulfur(S), and colloidal sulfur.

It is preferred that the content of the cross-linking accelerator is 0.1 to 6 parts by weight based on 100 parts by weight of the raw rubber, in that it can maximize the improvement of the productivity through acceleration of the vulcanization speed and the improvement of the rubber properties.

The cross-linking accelerator is an accelerator that accelerates the vulcanization speed or accelerates the delay of the vulcanization step. Specifically, any one selected from a group consisting of TMTD (tetramethylthiuram disulfide), MBTS (2,2′-dithiobis(benzothiazole)) and a mixture thereof can be used, although not being particularly limited thereto.

The cross-linking activator is in combination with the cross-linking accelerator to completely achieve the accelerating effect. Any one selected from a group consisting of an inorganic cross-linking activator, an organic cross-linking activator, and a combination thereof may be used. As the inorganic cross-linking activator, any one selected from a group consisting of zinc oxide (ZnO), zinc carbonate, magnesium oxide (MgO), lead oxide, potassium hydroxide, and a combination thereof may be used. As the organic cross-linking activator, any one selected from a group consisting of stearic acid, zinc stearate, palmitic acid, linoleic acid, oleic acid, lauric acid, dibutyl ammonium oleate, a derivative thereof, and a combination thereof may be used.

In particular, as the cross-linking activator, zinc oxide and stearic acid may be used together. In this case, zinc oxide dissolves in stearic acid to form an effective complex with the cross-linking accelerator, thereby creating sulfur advantageous for the vulcanization reaction and facilitating the cross-linking reaction of the rubber.

When zinc oxide and stearic acid are used together, for appropriate function as the cross-linking activator, the content of the cross-linking activator may be 1 to 10 parts by weight based on 100 parts by weight of the raw rubber (1 to 5 parts by weight based 100 parts by weight of the raw rubber for each).

A molded product prepared from the bio-based thermoplastic vulcanizate has excellent ecofriendliness, low cost and excellent mechanical strength, although it contains a high content of biomass.

There is no particular limitation on the shape of the bio-molded product, and can be appropriately selected depending on the use and purpose of the molded product. It can have various shapes, such as plate, rod, sheet, film, cylinder, ring, circle, ellipse, polygon, irregular, hollow, frame, box, panel, and special shapes.

Since the bio-molded product is not only ecofriendly but also has excellent mechanical strength, it can be specifically used for an envelope, a storage container, an airtight container, a display component, a portable terminal component, a household electrical appliance, an automobile component, a railway axle member, an aircraft member, or an indoor lighting component.

In another aspect, the present disclosure provides a method for preparing a bio-molded product.

The present disclosure relates to a method for preparing a bio-based thermoplastic vulcanizate, including a step of preparing a thermoplastic vulcanizate by thermomechanically kneading or mixing a composition containing a matrix resin containing raw rubber and bio-polypropylene; a sulfur cross-linking agent; a cross-linking accelerator; and a cross-linking activator at 180 to 190° C.

The description of the types, contents, etc. of the matrix resin containing the raw rubber and the bio-polypropylene; the sulfur cross-linking agent; the cross-linking accelerator; and the cross-linking activator will be omitted since they are the same as those of the bio-based thermoplastic vulcanizate described above.

The thermomechanical kneading or mixing process can be performed using a conventional method used in the related art. For example, the mixing and cross-linking process can be performed using a roll mill, a Banbury mixer, an internal mixer, a continuous mixer, a kneader, a mixing extruder, etc., although not being limited thereto.

In the mixing process, the raw rubber and the bio-polypropylene, excluding the cross-linking agent, the cross-linking accelerator, and the cross-linking activator, are mixed first. At this time, the matrix resin composition is prepared by mixing at specifically 100 to 190° C. for 10 to 20 minutes. Next, the cross-linking agent, the cross-linking accelerator, the cross-linking activator, etc. are mixed into the matrix resin composition, and in the cross-linking process, a composition is prepared by mixing at temperature 180 to 190° C. for 5 to 15 minutes, and then extruding the mixture.

The bio-based thermoplastic vulcanizate prepared through the above steps can be prepared into a pellet form through injection molding and extrusion.

These bio-based thermoplastic vulcanizate reduces the use of petroleum-derived raw materials, enables resources saving and environmental protection, and exhibits excellent performance. Specifically, since it provides superior tensile properties and processability during preparation, it is possible to obtain molded products with excellent heat resistance, water resistance, and durability. Therefore, it can be appropriately used as an ecofriendly material that is friendly to the global environment, for, e.g., not only automobiles but also daily lives, such as architecture, medicine, sports, footwear, etc.

Hereinafter, the present disclosure will be described in more detail through examples, etc. However, the scope and content of the present disclosure cannot be interpreted as being reduced or limited by the examples, etc. below. Furthermore, based on the disclosure of the present disclosure including the examples below, it is obvious that those skilled in the art can easily practice the present disclosure, even when specific experimental results are not presented, and modifications and variations thereof are also within the scope of the appended claims.

### <Examples and Comparative Example> Preparation of Ecofriendly Thermoplastic Vulcanizates

Bio-based polypropylene (Circulen Renew EP448T) (specific gravity: 0.90 g/mL, MI: 48 (230° C./2.16 kg) was purchased from Lyondell Basell. Circulen Renew EP448T is a renewable, non-biodegradable bio-based polypropylene prepared from bio-based waste. Moplen EP448T (Lyondell Basell) (specific gravity: 0.90 g/mL, MI: 48 (230° C./2.16 kg)), which has the same physical properties as non-biodegradable bio-based polypropylene, was prepared as petroleum-based polypropylene.

Keltan 8550C (ARLANXEO) (specific gravity: 0.86 g/mL, Mooney viscosity [ML 1+4, 125° C.]): 80 MU) was purchased as petroleum-based EPDM (ethylene propylene diene monomer) rubber, and Keltan ECO 8550C (ARLANXEO) (specific gravity: 0.86 g/mL, Mooney viscosity [ML 1+4, 125° C.]: 80 MU) was purchased as bio-EPDM (ethylene propylene diene monomer) rubber.

Sulfur (Alfa Aesar) was used as a cross-linking agent, and TMTD (tetramethylthiuram disulfide) and MBTS (2,2′-dithiobis(benzothiazole)) purchased from Sigma-Aldrich were used as cross-linking accelerators. As cross-linking activators, S/A (stearic acid) and ZnO (zinc oxide) were purchased from Daejung Chemical Co., Ltd.

The materials were added to an internal mixer as described in Table 1, and a thermoplastic vulcanizate (TPV) was prepared by performing mixing and cross-linking reaction at 185° C. and a rotor speed of 60 rpm for 16 minutes. A sample was injection-molded from the TPV at a cylinder temperature of 175° C. to 220° C. The physical properties of the molded sample were measured using the methods described in the test examples below.

TABLE 1

| | | Comparative | | |
|---|---|---|---|---|
| | | Example 1 | Example 1 | Example 2 |
| Petroleum-based EPDM | | 60 | 60 | — |
| (Keltan 8550C) | | | | |
| (wt %) | | | | |
| Bio-EPDM | | — | — | 60 |
| (Keltan ECO 8550C) | | | | |
| (wt %) | | | | |
| Petroleum-based PP | | 40 | — | — |
| (Moplen EP448T) | | | | |
| (wt %) | | | | |
| Bio-PP | | — | 40 | 40 |
| (Circulen Renew EP448T) | | | | |
| (wt %) | | | | |
| Cross-linking agent (sulfur)* | | 1 | 1 | 1 |
| (parts by weight) | | | | |
| Cross-linking accelerator* | TMTD | 5 | 5 | 5 |
| (parts by weight) | | | | |
| Cross-linking accelerator* | MBTS | 0.25 | 0.25 | 0.25 |
| (parts by weight) | | | | |
| Cross-linking activator* | S/A | 1 | 1 | 1 |
| (parts by weight) | | | | |
| Cross-linking activator* | ZnO | 5 | 5 | 5 |
| (parts by weight) | | | | |

In Table 1, the unit of the constituents, wt %, is the content ratio based on to the total weight of the matrix resin consisting of EPDM and PP, and the parts of weight indicated by * is the content ratio based on 100 weight parts of the petroleum-based or bio-EPDM rubber.

### <Test Example 1> Analysis of Physical Properties of Ecofriendly Thermoplastic Vulcanizate According to Present Disclosure

The physical properties of the ecofriendly thermoplastic vulcanizates prepared in the examples and comparative example were measured as follows. Tensile strength and elongation at break were determined according to ISO 37 (cross head: 500 mm/min), TGA (thermogravimetric analysis) was performed according to a known method at a heating rate of 5° C./min in a range of 10-600° C., DSC (differential scanning analysis) was performed according to a known method at a heating rate of 5° C./min in a range of 30-220° C., hardness was measured according to ASTM D2240 (Shore D), and compression set was measured according to ISO 815 (22 h, 70° C.).

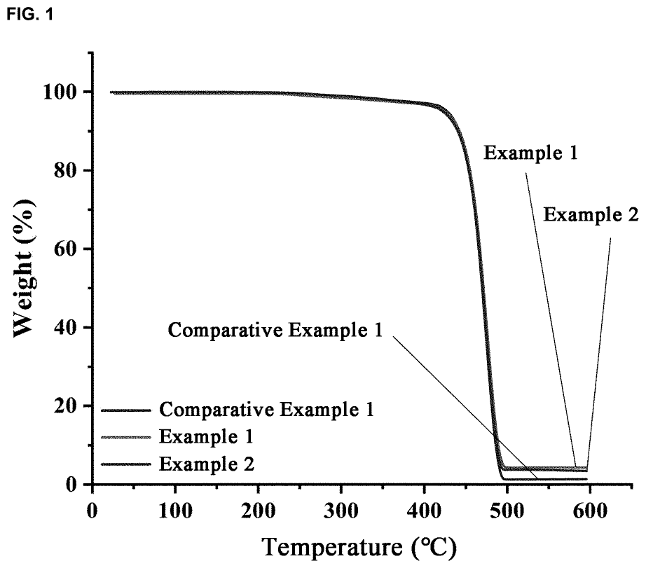

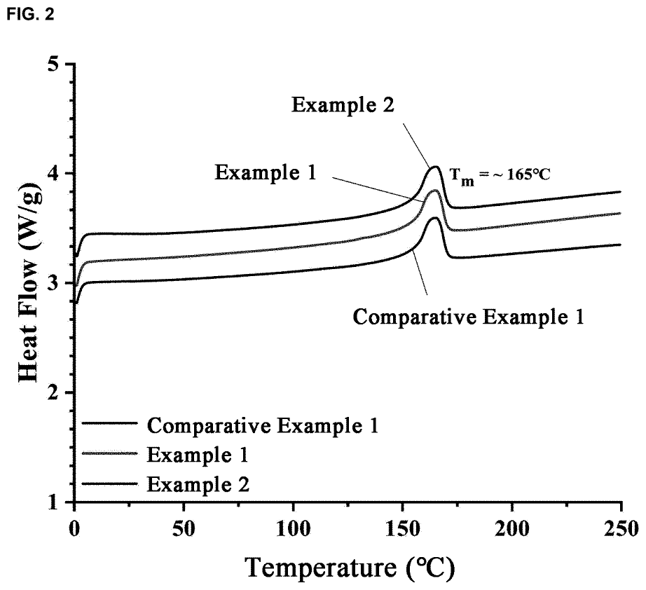

FIG. 1 shows the TGA curves of the thermoplastic vulcanizates prepared in Examples 1 and 2 and Comparative Example 1, and FIG. 2 shows the DSC curve results of the thermoplastic vulcanizates prepared in Examples 1 and 2 and Comparative Example 1.

As shown in FIGS. 1 and 2, it was confirmed that the thermoplastic vulcanizates of Examples 1 and 2 had properties equivalent to those of the existing thermoplastic vulcanizates such as that of Comparative Example, even though they contained bio-PP only rather than petroleum-based PP. In particular, Examples 1 and 2 showed excellent thermal stability with the decomposition temperature as high as approximately 500° C. even though the petroleum-based PP was entirely replaced with bio-PP. In addition, it was confirmed that the thermoplastic vulcanizates of Examples 1 and 2 had excellent processability since Tₘ was as high as 165° C.

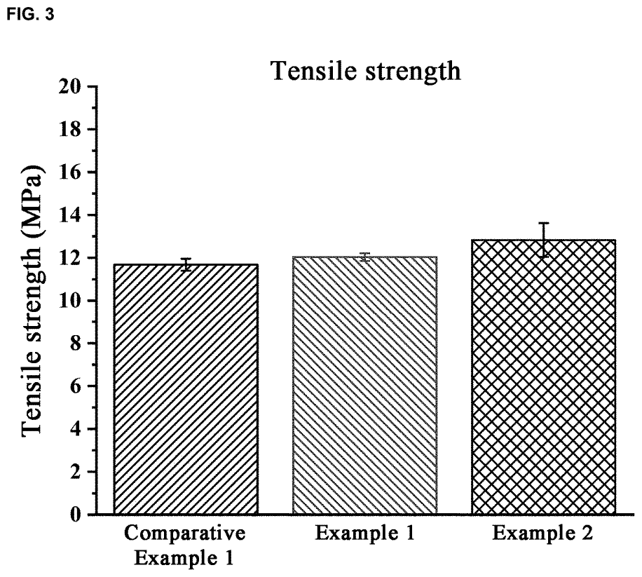

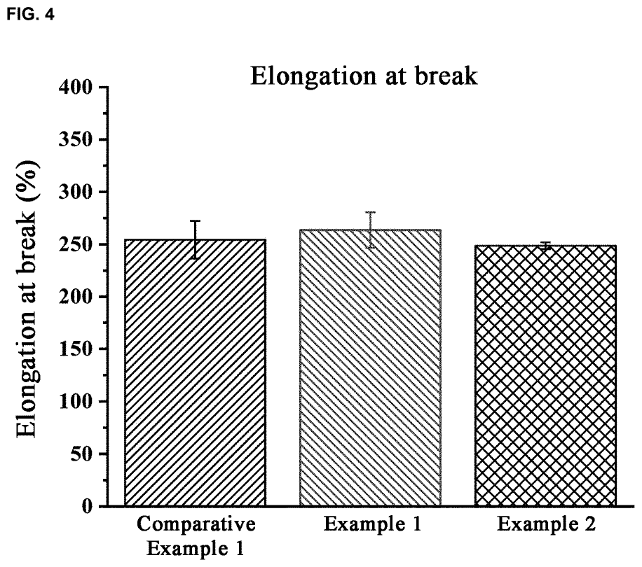

FIG. 3 shows the tensile strength of the thermoplastic vulcanizates prepared in Examples 1 and 2 and Comparative Example 1, and FIG. 4 shows the elongation at break of the thermoplastic vulcanizates prepared in Examples 1 and 2 and Comparative Example 1.

As shown in FIGS. 3 and 4, it was confirmed that the thermoplastic vulcanizates of Examples 1 and 2 had physical properties equivalent to those of the existing thermoplastic vulcanizates such as that of Comparative Example, even though they contained only bio-PP rather than petroleum-based PP. In particular, it was confirmed that the thermoplastic vulcanizate of Example 2 with the highest biomass content had excellent tensile strength. In general, when the content of bio-based polymer increases, some of the physical properties deteriorate due to the compatibility issue. However, it was confirmed that the thermoplastic vulcanizate prepared using the composition of the present disclosure did not exhibit a significant decrease in both tensile strength and elongation and but maintained them at the same levels.

That is, it was confirmed that, Examples 1 and 2, wherein petroleum-based PP was completely replaced by bio-PP, showed excellent mechanical properties with tensile strength of 12-13 MPa and an elongation at break of 250-270%, while exhibiting superior ecofriendliness.

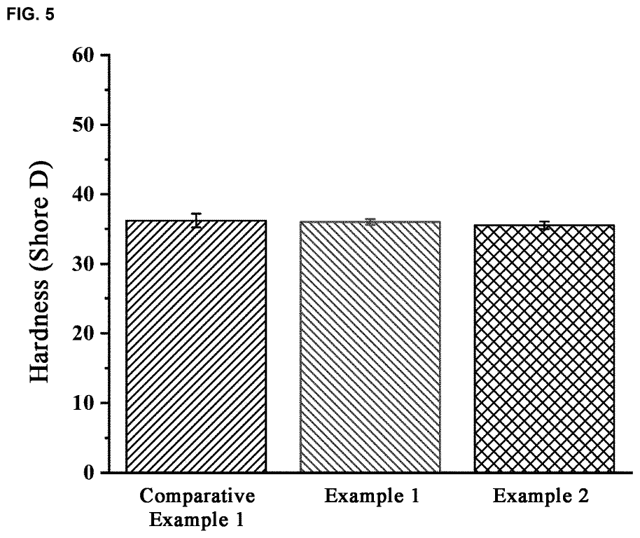

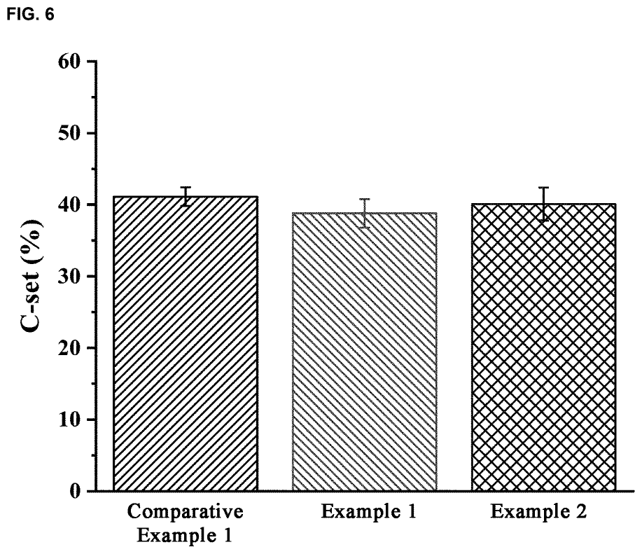

FIG. 5 shows the hardness of the thermoplastic vulcanizates prepared in Examples 1 and 2 and Comparative Example 1, and FIG. 6 shows the compression set of the thermoplastic vulcanizates prepared in Examples 1 and 2 and Comparative Example 1.

As shown in FIGS. 5 and 6, the thermoplastic vulcanizates of Examples 1 and 2 were confirmed to have comparable hardness and compression as compared to the existing thermoplastic vulcanizates such as that of Comparative Example, even though they contained bio-PP only rather than petroleum-based PP. In general, when the content of bio-based polymer increases, some of the physical properties deteriorate due to compatibility issues, but it can be confirmed that the thermoplastic vulcanizate manufactured using the composition of the present disclosure exhibits excellent physical properties at an equivalent level or higher while maintaining excellent levels of compression set and hardness.

1. A bio-based thermoplastic vulcanizate comprising: a matrix resin comprising raw rubber and bio-polypropylene;
a sulfur cross-linking agent;
a cross-linking accelerator; and
a cross-linking activator.

2. The bio-based thermoplastic vulcanizate according to claim 1, wherein the content of the raw rubber is 60 to 70 wt %, and the content of the bio-polypropylene is 30 to 40 wt % based on to the total weight of the matrix resin.

3. The bio-based thermoplastic vulcanizate according to claim 1, wherein
the raw rubber is one or more selected from natural rubber, synthetic rubber and bio-based rubber,
the synthetic rubber is one or more selected from a group consisting of ethylene-propylene-diene monomer (EPDM) rubber, styrene-butadiene rubber (SBR), butadiene rubber (BR), nitrile rubber (acrylonitrile-butadiene rubber, NBR), polychloroprene rubber, ethylene propylene rubber, urethane rubber, acrylic rubber, Hypalon rubber (CSM), fluorine rubber (FKM), perfluorinated rubber (FFKM), fluorosilicone rubber (FVMQ), and silicone rubber (VMQ), and
the bio-based rubber is one or more selected from a group consisting of bio-ethylene-propylene-diene monomer (bio-EPDM) rubber, bio-butadiene rubber (bio-BR), and bio-thermoplastic polyurethane (bio-TPU).

4. The bio-based thermoplastic vulcanizate according to claim 1, wherein
the raw rubber is bio-EPDM, and
the bio-EPDM rubber has a specific gravity of 0.8 to 0.9 g/mL and a Mooney viscosity of 75 to 85 at 125° C.

5. The bio-based thermoplastic vulcanizate according to claim 1, wherein the bio-polypropylene is polypropylene produced from bioethanol.

6. The bio-based thermoplastic vulcanizate according to claim 1, wherein the bio-polypropylene satisfies the physical properties (1) and (2):
(1) specific gravity: 0.9 to 1 g/mL; and
(2) melt index: 40 to 50 g/10 min (220° C., 2.16 kg).

7. The bio-based thermoplastic vulcanizate according to claim 1, wherein the content of the cross-linking agent is 0.5 to 1.5 parts by weight based on 100 parts by weight of the raw rubber.

8. The bio-based thermoplastic vulcanizate according to claim 1, wherein the content of the cross-linking accelerator is 0.1 to 6 parts by weight based on 100 parts by weight of the raw rubber.

9. The bio-based thermoplastic vulcanizate according to claim 1, wherein the content of the cross-linking activator is 1 to 10 parts by weight based on 100 parts by weight of the raw rubber.

10. The bio-based thermoplastic vulcanizate according to claim 1, wherein
the cross-linking accelerator is any one selected from a group consisting of TMTD (tetramethylthiuram disulfide), MBTS (2,2′-dithiobis(benzothiazole)) and a mixture thereof, and
the cross-linking activator is any one selected from a group consisting of S/A (stearic acid), ZnO (zinc oxide), and a mixture thereof.
